(19) United States
(12) Patent Application Publication
(10) Pub. No.: US 2002/0111895 A1
(43) Pub. Date: Aug. 15, 2002

(54) System and method for creating catalog neutral products

(76) Inventor: William R. Blair, Erie, PA (US)

Correspondence Address: Morgan, Lewis & Bockius LLP, 1701 Market Street, Philadelphia, PA, 19103-2921, US

(21) Appl. No.: 09/783,747

(22) Filed: Feb. 15, 2001

(51) Int. Cl. G06F 17/60

(52) U.S. Cl. 705/37

(57) ABSTRACT

A system that identifies functionally equivalent components and aggregates orders with functionally equivalent components from multiple buyers to create an on-line auction. The system includes private client catalogs, a generic component specification, a stock keeping unit (SKU) neutral catalog, an auction, a integrated supplier, a public catalog, and a list of suppliers and their associated products as identified by unique supplier-generated functional part numbers. Buyers, in the system, use the private client catalogs to purchase components from suppliers. When an order is placed into the private catalog, a generic component specification is generated for each component in order to identify functionally equivalent components. Thereafter, a SKU neutral number is assigned to all functionally equivalent components. The system identifies all functionally equivalent components in the SKU neutral catalog by their SKU neutral number. At a predetermined time, aggregated orders are generated by combining multiple orders with the same SKU neutral number and suppliers of those functionally equivalent components in the aggregated orders are invited to the auction. After the auction, the integrated supplier manages the components and delivers them to the buyers at an appropriate time. The inventive system therefore creates a strategically timed market that is favorable to buyers by creating an auction with aggregated components from multiple buyers.

### FIELD OF THE INVENTION

The present invention relates to a system and method for conducting electronic auctions. The invention particularly relates to a system and method for identifying functionally equivalent products, aggregating orders for these products, and increasing the frequency in the time to market for these products, thereby obtaining leverage in the varying degree of inventory carried by suppliers.

### BACKGROUND OF THE INVENTION

Procurement of supplies has traditionally involved high transaction costs, especially information search costs. The introduction of electronic commerce has introduced new methods of procurement that lower some of the transaction costs associated with procurement. Online procurement, in particular business-to-business electronic commerce, matches buyers and suppliers so that transactions can take place electronically.

Four models of online procurement have been developed: catalog, buyer-bidding auctions, seller-bidding auctions and exchange marketplaces.

The “catalog” model of online procurement was the first to be developed. The first electronic catalogs were developed by sellers, typically suppliers, to help customers obtain information about products, and order supplies electronically. These first electronic catalogs were single-source; i.e. they only allowed customers to obtain information and products from that supplier.

Although these first electronic catalogs greatly reduced the information search costs of procurement, customers were not satisfied with being “locked in” to one supplier—customers wanted to be able to compare a number of competing products. Therefore suppliers with single-source catalogs started to include competitors' products in their systems. An example of this is American Airlines SABRE system, which includes offerings from competing suppliers, i.e. other airlines. The inclusion of competing products in electronic catalogs reduced procurement information search costs even further. By offering competing products, electronic catalogs became “electronic markets”.

However, many of these catalog systems are biased toward the supplier offering the electronic catalog. Procurement costs can be lower further still through an unbiased market. Therefore, third-party “market makers” have developed unbiased markets for many standard products and services. For example, Inventory Locator Services offers a database listing all airplane parts suppliers that have certain standard items in stock.

Electronic commerce using the electronic catalog model typically involves one buyer and one seller at a time. When many buyers compete for the right to buy from one seller, a buyer-bidding auction model is created. A noteworthy example of the buyer-bidding auction model is that operated by PriceLine.com and described in U.S. Pat. No. 5,794,207 issued to Walker et al. In this system, potential buyers compete for airline tickets by submitting bids for an airline ticket on the PriceLine website, and airlines can choose to accept any given bid.

The catalog and buyer-bidding auction models do not work in some situations, however. For example, if a buyer requires a custom product, it is not possible for suppliers to publish set prices for a catalog market. Likewise, it is difficult to identify the product for a buyer-bidding auction, and additionally, there may be only one buyer interested in the custom product. There are fewer suppliers and no standard product and pricing information available for the buyer of custom industrial products.

Traditionally, when a company requires a custom product, a buyer for the company procures the product by searching for potential suppliers, then acquiring price quotes from the potential suppliers for the needed custom product. The search is slow and random, and typically relies heavily on personal relationships. The costs associated with locating vendors, comparing prices, and negotiating a deal are large. The cost of switching suppliers is also very large, which means that an incumbent supplier's quoted price is most likely not the lowest price he could offer because the incumbent supplier knows the buyer would face switching costs to use another supplier. As an additional consequence, new suppliers have a difficult time entering the market.

Therefore, supplier-bidding auctions for products defined by a buyer have been developed. The assignee of the present application has developed a system in which sellers downwardly bid against one another to achieve the lowest market price in a supplier-bidding auction.

In a supplier-bidding auction, or reverse auction, bid prices start high and move downward as bidders interact to establish a closing price. Typically, the auction marketplace is one-sided, with one buyer and many potential suppliers, although multiple-buyer auctions are possible. Typically, the products being purchased are components or materials. “Components” may include fabricated tangible pieces or parts that become parts of assemblies of durable products. Examples of components include gears, bearings, and appliance shelves. “Materials” may include bulk quantities of raw materials that are further transformed into products. Examples of materials include corn syrup and sheet steel.

Even when buyers participate in supplier-bidding auctions, there are certain commodities that buyers purchase outside of the supplier-bidding auction that are not competitive purchase items and not strategic for business. These commodities are generally Maintenance, Repair and Operations (MRO) components, such as spare parts and maintenance supplies, used to operate factories and equipment. MRO components are characterized as “indirect” material, i.e., material not used directly in the end product of a manufacturer. Knowing how much of these components a competitor is purchasing does not offer the buyer clues on how to compete in the market. Typically, each buyer purchases desired MRO components by entering into long-term contracts with individual suppliers.

Some MRO components are functionally equivalent with other MRO components, i.e., they have the same functional characteristic and specification. Thus, for example, in the specification for functionally equivalent xerography copy paper characteristics, such as color, weight, sheets per carton, smoothness, brightness, opacity, and the recycle requirement, have the same value. Each functionally equivalent MRO component also has a unique supplier-generated functional part number. Buyers use the functional part numbers to purchase MRO components. Currently, there is no uniform method of using the functional part number to determine functionally equivalent components in order to substitute one component for another. Moreover, since buyers cannot easily determine functional equivalent components, they have no way of aggregating orders that include functional equivalent components to increase the purchasing volume and obtain a favorable price from suppliers. Thus, individual buyers generally enter into long-term contracts with individual suppliers to purchase individual MRO components.

Since suppliers can anticipate future inventory based on existing contracts, suppliers are able to determine future needs and maintain their inventory accordingly. This enables suppliers to control the market and set prices that are more favorable to them. What is needed, therefore, is a system and method for determining functionally equivalent components and for aggregating orders with functionally equivalent components to create a volume that is large enough for a periodic auction. This creates inventory uncertainty and disparities among suppliers. Since idle inventories cost the suppliers money, the method of purchasing functionally equivalent components through periodic auction encourages suppliers to offer better prices to the buyers.

### SUMMARY OF THE INVENTION

The present invention is directed to a method and apparatus for procuring functionally equivalent components based on aggregated orders for multiple buyers. A plurality of orders to procure components from a plurality of buyers are received. Each order includes identifying information and a volume required for each component in the order. A stock-keeping unit (SKU) tool generates a generic specification for each component and assigns a unique SKU number to each group of functionally equivalent components with the same characteristics. All orders for each group of functionally equivalent components having the same unique number are aggregated. Next, an on-line auction is conducted, wherein suppliers of the aggregated functionally equivalent components submit bids to supply the components to the buyers during the on-line auction. At least one winning supplier is selected in accordance with an outcome of the auction. In one embodiment, after the conducting of the auction, on-line auction information is stored in a buyer catalog, and one or more of the plurality of buyers use the on-line auction information in the buyer catalog to thereafter contract with at least one supplier.

In another embodiment of the present invention, a system administrator enters a generic specification for each component. The invention then generates a unique SKU neutral number for each group of functionally equivalent components, and stores the specification and SKU neutral number in a public catalog. Thereafter, when a buyer is purchasing a component, the buyer enters the generic specification, the required delivery date, the SKU neutral number, or the functional part number and the volume required into the system. The system uses the SKU neutral number to identify all functionally equivalent components. At a subsequent predetermined time, the system aggregates all orders with the same SKU neutral number and determines if there is a desired volume for an auction. Upon obtaining the desired volume, the system then sets up an on-line auction. One or more suppliers of the functionally equivalent components in the aggregated orders are invited to participate in the auction.

Prices from the auction determine new price(s) of the functionally equivalent components. An integrated supplier or fulfillment partner buffers and inventories the auctioned components and delivers them to buyers at a required time. In an alternate embodiment, the auction components are delivered directly to the buyers. The contract price and information from the auction is populated into one or more industry standard catalogs or individual catalogs associated with buyers. This enables the buyers to contract with one or more suppliers based on the auction terms. Therefore, the inventive system leverages disparity in inventory by decreasing the contract period around components that are functionally equivalent. The system also creates a market by consolidating the demand for components that buyers do not normally compete on.

In accordance with a further aspect, the inventive system allows an integrated supplier to transfer purchasing activity for MRO components to an outside company. In the system, the integrated supplier processes invoices from the on-line auction and also may buffer inventory for the buyers. Hence, the integrated supplier eliminates the need to outsource the purchasing activity for certain products.

Additional features and advantages of the invention will be set forth in the description that follows, and in part will be apparent from the description, or may be learned by practice of the invention. The objectives and advantages of the invention will be realized and attained by the system particularly pointed out in the written description and claims hereof as well as the appended drawings.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention.

In the drawings:

FIG. 1 illustrates the functional elements and entities in setting up and conducting a typical supplier-bidding auction;

FIG. 1A illustrates the creation of an auctioning event;

FIG. 1B illustrates the bidding during an auction;

FIG. 1C illustrates results after completion of a successful auction;

FIG. 2 illustrates connection between the auction and a computer network;

FIG. 3a illustrates a system for identifying functionally equivalent components and aggregating orders with functionally equivalent components from multiple buyers into an on-line auction;

FIG. 3b illustrates how SKU neutral information is generated from different specifications supplied by multiple suppliers; and

FIG. 4 illustrates the steps implemented in the system of FIG. 3.

### DESCRIPTION OF THE PREFERRED EMBODIMENTS

Reference will now be made in detail to the preferred embodiments of the present invention, examples of which are illustrated in the accompanying drawings. The present invention described below explains the functionality of the inventive system and method for identifying functionally equivalent components and for aggregating orders with functionally equivalent components in an on-line auction.

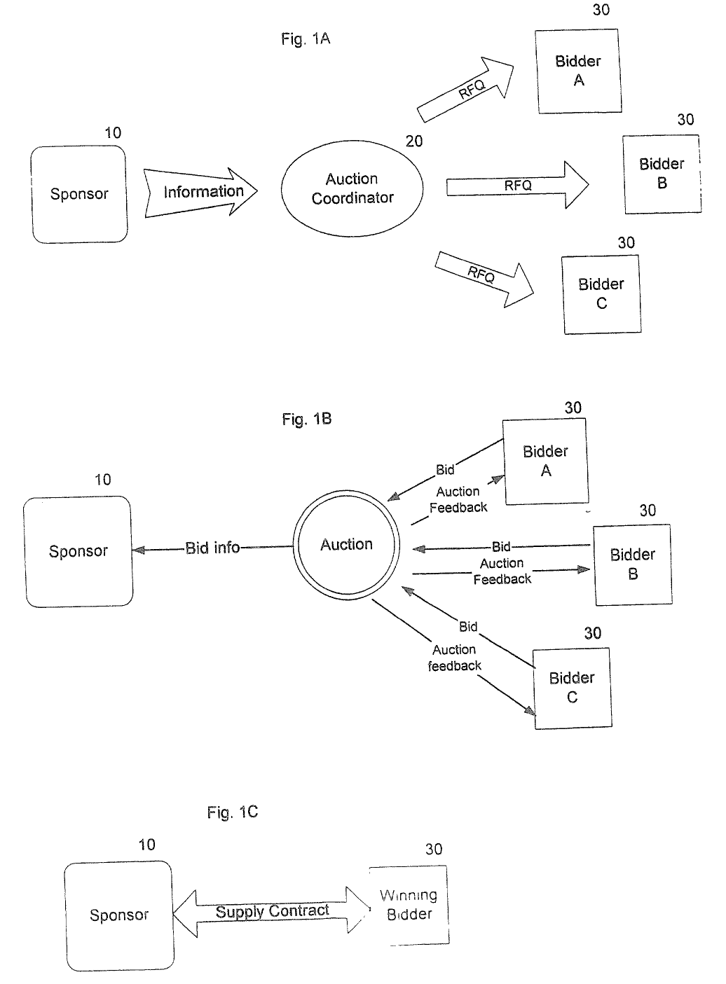

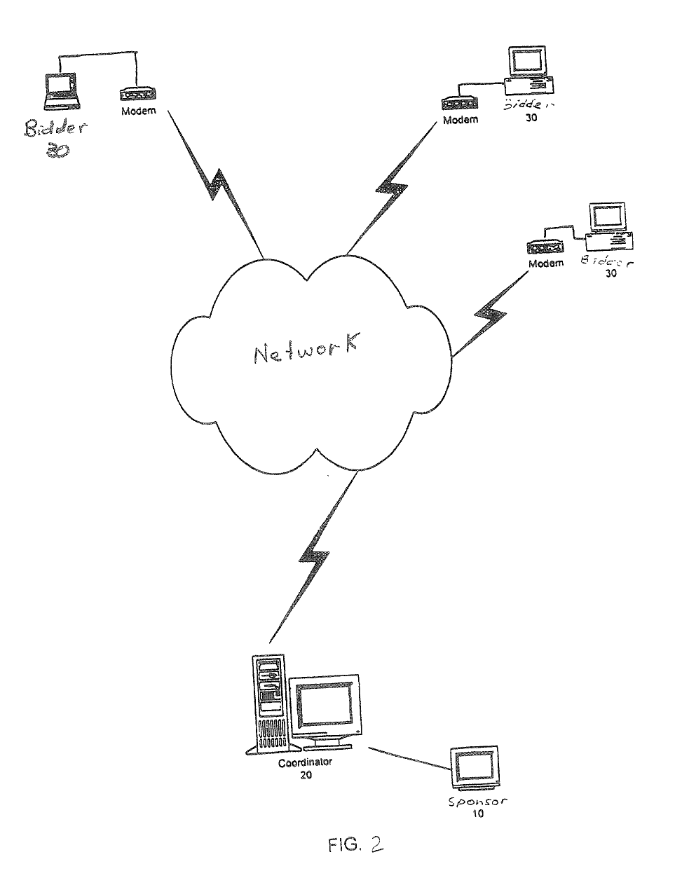

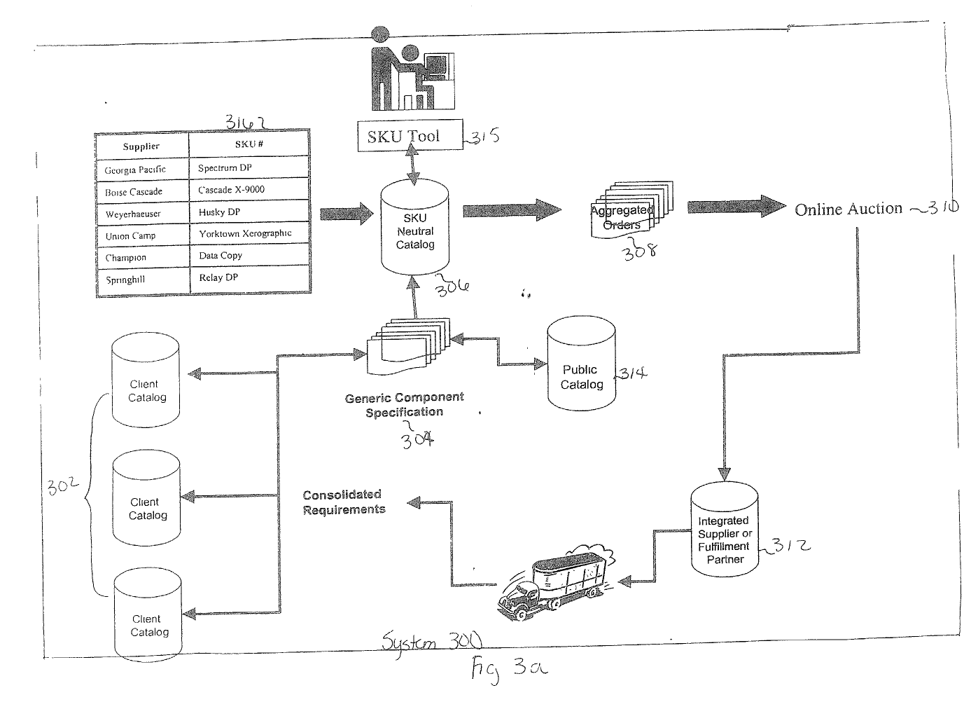

The basic process for a supplier-bidding auction as conducted by the assignee of the present invention is described below with reference to FIG. 1. FIG. 1 illustrates the functional elements and entities in setting up and conducting a typical supplier-bidding auction. FIG. 1A illustrates the creation of an auctioning event, FIG. 1B illustrates the bidding during an auction, and FIG. 1C illustrates results after completion of a successful auction.

As will be apparent to one skilled in the art, while the invention is generally described in terms of one buyer and multiple suppliers, the present invention may also be used in other types of electronic markets, such as auctions with multiple buyers and multiple sellers, upward-bidding auctions, or electronic exchange marketplaces.

In the typical supplier-bidding auction model, the bidding product or service is defined by the sponsor of the auction. The sponsor is typically an industrial buyer, but may be another type of buyer, seller or anyone else who needs to have an auction conducted. As shown in FIG. 1A, when the sponsor of the auction 10 decides to use the auctioning system of the present invention to procure products or services, the sponsor provides information to an auction coordinator 20. This information may include information about incumbent suppliers and historic prices paid for the bidding products or services, for example. Typically, the sponsor works with the auction coordinator to define the bidding products and services, and if desired, lot the products and services appropriately so that the needed products and services can be procured using optimal auction dynamics. A specification is prepared for each desired product or service and a stock keeping unit (SKU) neutral component template is generated for the auction. The SKU neutral component template stores a generic specification for the desired product or service.

The auction coordinator 20 identifies potential bidders who are typically suppliers 30, preferably with input from the sponsor, and invites the potential bidders to participate in the upcoming auction. The potential bidders are given access to the SKU neutral component template, such as a browser-based template or a printed published template document.

As shown in FIG. 1B, during a typical auction, bids are made against lots. Generally, bidders must determine their bid for a lot based on actual unit prices for all line items in the lot, however, the competition in an auction is based on the aggregate value bid for a lot. The aggregate value bid for a lot depends upon the level and mix of line item bids and the quantity for each line item. Therefore, although bidders may calculate bids at the line item level, they are competing on the lot level. For example, suppliers A, B, and C may produce products 1, 2, and 3 and supplier D may produce product 1, 2, 3, and 4. A lot may include varying quantities of products 1, 2, and 3 and suppliers A, B, C, and D may be invited to bid on the lot. Each supplier may bid on the lot by placing an aggregate value bid for all products and the lot is generally dependent on the broadest number of products defined by the participating suppliers.

Buyer-optimal lot selection is facilitated by the compilation of the SKU neutral data, i.e. the make-up of lots can be based at least in part on the suppliers that satisfy the SKU neutral requirements for any number of items. For example, it may be that, for a buyer that has a need for fifteen different products within different SKU neutral templates, six of ten suppliers (bidders) that meet at least some of the SKU neutral criteria actually meet these criteria for all fifteen products. Greater savings for the buyer may be realized by having one lot with just those six suppliers bidding to supply all fifteen products. It may also be that, while six of ten suppliers can supply all fifteen products, eight of ten can supply the two largest-ticket products, and only four of these eight suppliers are in the group of six suppliers that can supply all fifteen products. In this case, greater savings may be achieved by having two lots, one with just the two big-tickets products and eight suppliers bidding and the other lot with the remaining thirteen products and all qualified suppliers (in this example, at least six) bidding.

During the auction, the sponsor can typically monitor the bidding as it occurs. Bidders may also be given some feedback on the auction activity so that they may bid competitively. After the auction, the auction coordinator may analyze the auction results with the sponsor. In a reverse auction, the sponsor typically conducts final qualification of the low bidding supplier(s). The sponsor may retain the right not to award business to a low bidding supplier based on final qualification or other business concerns. As shown in FIG. 1C, at least one supply contract is usually drawn up and executed based on the results of the auction.

The auction is conducted electronically between potential bidders 30 at their respective remote sites and the auction coordinator 20 at its site. In an alternative embodiment, instead of the auction coordinator 20 managing the auction at its site, the sponsor 10 may perform auction coordinator tasks at its site.

Information is conveyed between the coordinator 20 and the bidders 30 via any known communications medium. As shown in FIG. 2, bidders may be connected to the auction through a network such as the Internet via, for example dial-up telephone connections. Other methods of connecting and other communications mediums are known to those skilled in the art, and are intended to be included within the scope of the present invention.

A computer software application is used to manage the auction. The software application preferably has two components: a client component and a server component. Although the present invention is described in terms of a server component and a client component, one skilled in the art will understand that the present invention is not limited to a client/server relationship model, and may be implemented in a peer-to-peer communications model, or any other model known to those skilled in the art. The client component is used by the bidders to make bids during the auction, and to receive and display feedback from the auction. The client component may be a program that is installed on a bidder's computer, or it may be software that is accessed and run from a web site. Preferably, an Application Service Provider (ASP) implements the client component. Bids can only be submitted using the client component of the application, thereby ensuring that buyers cannot circumvent the bidding process, and that only invited suppliers participate in the bidding.

Bids are sent over the communications medium to the auction coordinator, or the sponsor, if the sponsor is performing auction coordination tasks. Bids are received by the server component. The client component includes software functions for making a connection over the Internet, or other medium, to the server component. Bids are submitted over this connection and feedback is sent to connected bidders.

When a bidder submits a bid, that bid is sent to the server component and evaluated to determine whether it is a valid or acceptable bid. Feedback about received bids is sent to all connected bidders enabling bidders to see changes in market conditions and plan competitive responses.

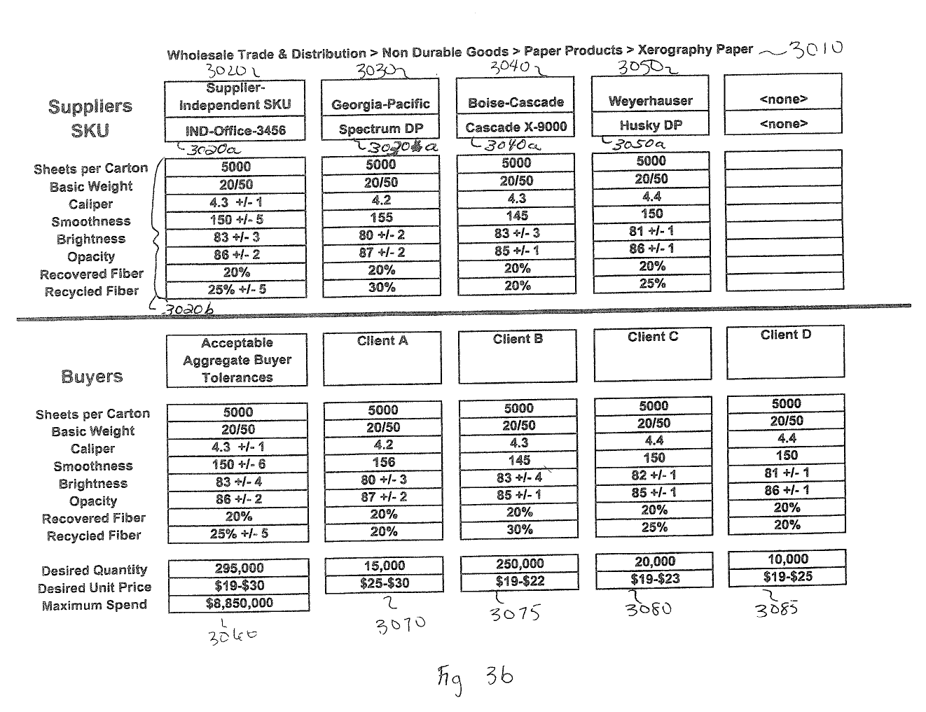

FIG. 3a illustrates an inventive system for identifying functionally equivalent components and aggregating orders with functionally equivalent components from multiple buyers to create the auction. System 300 includes private client catalogs 302, generic component specification 304, a SKU neutral catalog 306, aggregated orders 308, an auction 310, an integrated supplier or fulfillment partner 312, a public catalog 314, a SKU tool 315, and a list 316 of suppliers and their associated products as identified by unique supplier-generated functional part numbers. In the inventive system, buyers use private client catalogs 302 to purchase components from suppliers. When an order is placed into catalogs 302, the invention generates a generic component specification 304 for each component in order to identify functionally equivalent components offered by different ones of the suppliers. Thereafter, a unique SKU neutral number is assigned to each group of functionally equivalent components. All functionally equivalent components in SKU neutral catalog 306 are identified by their SKU neutral number. Periodically, aggregated orders 308 are generated by combining multiple orders (in one embodiment, the multiple orders are generated from different buyers) with the same SKU neutral number, and suppliers of those functionally equivalent components in the aggregated orders are invited to auction 310. After the auction, integrated supplier or fulfillment partner 312 buffers and inventories the components and delivers them to the buyers at an appropriate time. The inventive system therefore creates a strategically timed market that is favorable to buyers by creating an auction with aggregated components from multiple buyers.

Specifically, in a preferred embodiment of the invention, a system administrator uses SKU tool 315 to generate a generic specification 304 for each component and to assign a unique SKU neutral number to each group of functionally equivalent components. It should be noted that functionally equivalent components may be components with identical properties or components with properties that fall within a predefined parametric range. Specification 304 and the SKU neutral numbers for components in a broad range of categories are stored in public catalog 314. As new products are offered, the administrator enters the corresponding specification and SKU neutral numbers into public catalog 314. The administrator also may enter the unique supplier-generated functional part number assigned to each component in public catalog 314.

FIG. 3b illustrates how SKU neutral information is generated from different specifications supplied by multiple suppliers. As noted above, the SKU information may represent the collective tolerances of different suppliers and buyers. Row 3010 identifies the relevant supply market category, in this case, Xerographic paper. Columns 3030-3060 each represent the xerographic paper provided by a given supplier, including the different SKU numbers 3030a, 3040a, 3050a, 3060a, assigned to xerographic paper by each of the suppliers. Column 3020 illustrates supplier-independent SKU information for xerographic paper as generated by tool 315, including a unique SKU neutral number 3020a for xerographic paper, and a generic specification 3020b for xerographic paper. The rows in column 3020 represent the product properties for the corresponding SKU information. In one embodiment, tool 315 allows the system administrator or another user, such as a market maker, who would add and delete willing buyers and sellers until a desirable supplier-independent SKU specification is created, to choose information from drop-down menus. This enables the user to define each column separately. As is apparent to one skilled in the are, other methods may be used to define each column. Once the suppler-independent SKU information is created, an RFQ can be generated and an auction held with the participating suppliers. In one embodiment, SKU tool 315 automatically calculates the values in the supplier-independent SKU column 3020 based on the corresponding supplier-specific properties in columns 3030-3060.

Columns 3070-3090 represent the requirements desired by individual buyers. In one embodiment, SKU tool 315 automatically calculates the values in the acceptable aggregate buyer tolerance column 3060 based on the corresponding buyer-specific properties, and SKU tool 315 includes features which indicate whether proposed supplier-independent SKU information is within the acceptable aggregate buyer tolerances for all properties. The tool may optionally highlight gating factors, indicating those properties, which prevent a successful match of functionally equivalent components. SKU tool 315 may include expert-system features for automating most or all of the user's task via business rules developed in the course of using the tool.

Preferably when each buyer wants to purchase components, the buyer enters a supplier-generated functional part number (e.g., 3030a, 3040a, 3050a, 3060a) for each desired component into catalog 302. System 300 generates generic specification 304 for each group of functionally equivalent components and assigns a unique SKU neutral number (e.g., 3020a) to each group of functionally equivalent components. Alternatively, the buyer could enter the SKU neutral number for the desired component. Upon entering or obtaining the SKU neutral number, system 300 identifies all functionally equivalent components in SKU neutral catalog 306 and creates list 316 of all suppliers of the functionally equivalent components. Periodically, the coordinator aggregates all orders with the same unique SKU neutral number and determines if there is a desired volume for an auction. Upon obtaining the desired volume, the coordinator sets up on-line auction 310 and invites suppliers of functionally equivalent components to bid on the aggregated orders. The suppliers may bid on all or some of the components based on the auction rules.

After the bidding process is complete, the coordinator awards the contract to one or more suppliers and price(s) of winning supplier(s) determine new price(s) for the functionally equivalent components. Upon selecting the winning supplier(s), integrated supplier 312 inventories the components and delivers them to the buyers at a required time. In an alternate embodiment, the products may be delivered directly to the buyers. After the auction, the contract price and information from the auction is populated into one or more standard catalogs, such as catalogs 302 associated with buyers. For example, system 300 stores in catalogs 302 the contract price, period, delivery terms and all terms and conditions agreed on in the on-line auction, as well as the SKU neutral numbers associated with each component. This enables the buyers to contract with one or more winning suppliers based on the auction terms. For example, the buyer may contract with the supplier with the lowest price or the supplier with the largest inventory. After the auction, the system stores information, such as volume and price from the auction, in order to track market trends over time.

The inventive system also eliminates the need for the buyer to outsource purchasing activity for MRO components to an outside company. One reason why buyers outsource some purchasing activity is to reduce clerical accounts payable staff that may have to service thousands for invoices for MRO components. By outsourcing the purchasing activity, the buyer eliminates the accounts payable processing as a direct business cost although the buyer still has to pay the outside accounts payable company. In the inventive system, the integrated supplier processes the invoices from the on-line auction and also may buffer inventory for the buyers, thereby eliminating the need to outsource the purchasing activity for MRO components.

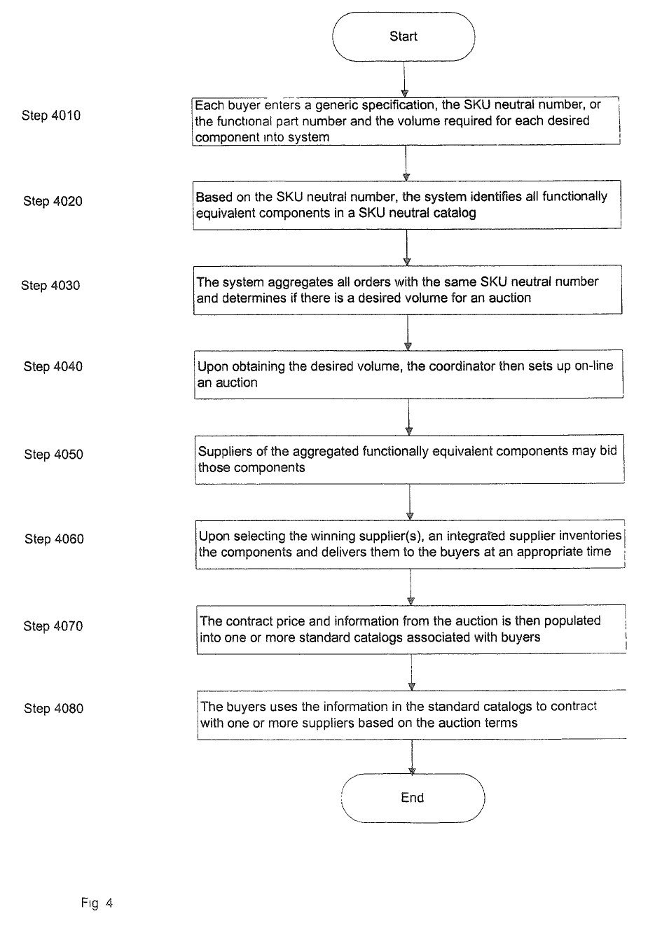

FIG. 4 illustrates the steps implemented in the inventive system. In Step 4010, when each buyer wants to purchase components, the buyer enters generic specification 304, the SKU neutral number, or the functional part number and the volume required for each desired component into system 300. In Step 4020, based on the SKU neutral number, system 300 identifies all functionally equivalent components in SKU neutral catalog 306. In Step 4030, at a subsequent predetermined time, system 300 aggregates all orders with the same SKU neutral number and determines if there is a desired volume for an auction. In Step 4040, upon obtaining the desired volume, the coordinator then sets up on-line auction 310. In Step 4050, suppliers of the aggregated functionally equivalent components may bid those components.

In Step 4060, upon selecting the winning supplier(s), integrated supplier 312 inventories the components and delivers them to the buyers at an appropriate time. In Step 4070, the contract price and information from the auction is then populated into one or more standard catalogs or catalogs 302 associated with buyers. In Step 4080, the buyers use the information in catalogs 302 to contract with one or more suppliers based on the auction terms.

The foregoing description has been directed to specific embodiments of this invention. It will be apparent, however, that other variations and modifications may be made to the described embodiments, with the attainment of some or all of their advantages. Therefore, it is the object of the appended claims to cover all such variations and modifications as come within the true spirit and scope of the invention.

What is claimed:

1. A method of procuring functionally equivalent components, over a network, based on aggregated orders from multiple buyers, comprising the steps of:
receiving a plurality of orders to procure components for a plurality of buyers, wherein each order includes identifying information and a volume required for each component in the order;
generating a generic specification for each component and assigning a unique number to each group of functionally equivalent components, wherein for each group of functionally equivalent components there is one unique number and a plurality of supplier generated functional part numbers; and
aggregating all orders for each group of functionally equivalent components having the same unique number wherein suppliers of the aggregated functionally equivalent components submit bids to supply the components to the buyers.

2. The method of claim 1, further comprising the step of storing the generic specification and unique number for each component in a public catalog.

3. The method of claim 1, further comprising the steps of conducting an on-line auction;
selecting at least on winning supplier in accordance with an outcome of the auction; and
storing on-line auction information in a buyer catalog, wherein after the conducting of the auction, ones of the plurality of the buyers use the on-line auction information in the buyer catalog to contract with at least one supplier.

4. The method of claim 3, further comprising the step of entering one or more supplier-generated functional part numbers for each component in the buyer catalog.

5. The method of claim 3, further comprising the step of entering the unique number for each component in the buyer catalog.

6. The method of claim 1, wherein the step of generating further comprises the steps of:
allowing a user to utilize a tool to add and delete columns of buyer and supplier information until supplier-independent information is created; and
automatically calculating, with the tool, the values in a supplier-independent column based on the corresponding values of properties in a plurality of supplier-specific columns.

7. The method of claim 6, wherein the step of generating further comprises the step of creating rows, in the supplier-independent column, that represent product properties for supplier-independent information.

8. The method of claim 6, wherein the step of generating further comprises the step of creating rows, in a plurality of columns, that represent product properties for supplier-specific information.

9. The method of claim 6, wherein the step of generating further comprises the step of choosing information from drop-down menus.

10. The method of claim 7, further comprising the step of using the suppler-independent information to generate a request for quotation for an auction to be held with participating suppliers.

11. The method of claim 1, wherein the step of aggregating further comprises the steps of:
obtaining requirements for the plurality of buyers;
using a tool to automatically calculate the values in an acceptable aggregate buyer tolerance column based on corresponding buyer-specific properties from the requirements.

12. The method of claim 11, wherein the step of obtaining further comprises the step of using the tool to determine whether proposed supplier-independent information is within an acceptable tolerance for each property.

13. The method of claim 11, wherein the step of obtaining further comprises the step of using the tool to highlight gating factors for indicating those properties which prevent a successful match of functionally equivalent components.

14. The method of claim 1, wherein the step of aggregating further comprises the step of retrieving all components with the same unique number from a database and retrieving information about suppliers of each component with the same unique number.

15. The method of claim 1, further comprising the step of conducting an on-line auction when there is a desired volume of aggregated orders.

16. The method of claim 3, further comprising the step of of setting a price from a winning supplier as a new price for the functionally equivalent components in the buyer catalog.

17. The method of claim 3, further comprising the step of using a fulfillment partner to deliver components from an on-line auction to the plurality of buyers.

18. The method of claim 3, further comprising the step of processing invoices from the auction and buffering inventory for the plurality of buyers by a fulfillment partner.

19. The method of claim 1, further comprising the step of creating functionally equivalent components with identical characteristics corresponding to each of a plurality of properties.

20. The method of claim 1, further comprising the step of creating functionally equivalent components having characteristics within a predefined range for each property.

21. A system of procuring functionally equivalent components, on a network, based on aggregated orders from multiple buyers, comprising:
a plurality of buyer catalogs for procuring components, wherein each of a plurality of buyers procures a component by entering information about the component in one of the plurality of buyer catalogs;
a public catalog for storing a generic specification and a unique number for each group of functionally equivalent components;
an auction catalog for identifying and retrieving functionally equivalent components and for identifying suppliers and information associated with the functionally equivalent components;
an on-line auction for procuring aggregated lots of functionally equivalent components from suppliers of the functionally equivalent components;
a tool in the system for using the information in the plurality of buyer catalogs to generate the generic specification and SKU neutral number for each component and for assigning the same SKU neutral number to each component with the same generic specification; and
means for aggregating requests for components with the same unique number prior to initiating the on-line auction and for storing information about the auction in the plurality of buyer catalogs after the auction, thereby enabling each of the plurality of buyers to contract with at least one winning supplier based on the terms of the auction.

22. A method of procuring functionally equivalent components, comprising the steps of:
receiving a plurality of orders to procure components for a plurality of buyers, wherein each order includes identifying information and a volume required for each component in the order;
generating a generic specification for each component and assigning a unique number to each group of functionally equivalent components;
aggregating all orders for each group of functionally equivalent components having the same unique number;
conducting an on-line auction wherein suppliers of the aggregated functionally equivalent components submit bids to supply the components to the buyers during the on-line auction and;
selecting at least one winning supplier in accordance with an outcome of the auction, and storing on-line auction information in a buyer catalog, wherein, after conducting of the auction, ones of the plurality of the buyers use the on-line auction information in the buyer catalog to contract with at least one supplier.

23. A method for creating a generic specification for a set of functionally equivalent components to aggregate a plurality of orders containing at least one functionally equivalent component, thereby increasing buying power of individual buyers, the method comprising the steps of:
choosing a set of parameters deem relevant to a purchasing decision for the set of functionally equivalent component;
comparing a plurality of acceptable tolerance ranges for each of the parameters;
deciding on a generic acceptable tolerance range based on the step of comparing; and
generating the generic specification for the set of functionally equivalent components, wherein the generic specification includes the generic acceptable tolerance range for each parameter.

24. The method of claim 23, wherein the step of deciding further comprises the step of choosing the narrowest tolerance that still affords a sufficiently broad set of functionally equivalent components.
